(19) United States
(12) Patent Application Publication
(10) Pub. No.: US 2006/0172916 A1
(43) Pub. Date: Aug. 3, 2006

(54) Use of a polymer dispersant as a fluidising agent for hydraulic binder compositions and preparation thereof

(76) Inventors: Manuel Hidalgo, Brignais (FR); Djamel Bensarsa, Lyon (FR); Martial Pabon, Courbevoie (FR); Fabio Giberti, Dugnano (IT); Jean-Marc Corpart, Lyon (FR)

Correspondence Address: WHYTE HIRSCHBOECK DUDEK S C, 555 EAST WELLS STREET, SUITE 1900, MILWAUKEE, WI, 53202, US

(21) Appl. No.: 10/547,626

(22) PCT Filed: Feb. 25, 2004
(86) PCT No.: PCT/FR04/00417

§ 371 Date: Apr. 12, 2006

(30) Foreign Application Priority Data
Mar. 3, 2003 (FR) 03/02576

(51) Int. Cl. C11D 3/37

(52) U.S. Cl. 510/475

(57) ABSTRACT

Polymer dispersant of polycarboxylate type comprising at least one copolymer obtained from a monomer composition comprising, in moles: A) 40 to 95% of at least one unsaturated carboxylic monomer, B) 5 to 60% of at least one acrylic ester or methacrylic ester monomer comprising a polyether chain, C) 0 to 20% of at least one third monomer selected from: acrylic ester or methacrylic ester or acrylamide or acrylamide derivative or vinylaromatic monomer or its sulphonated derivative, the copolymer having a controlled molecular mass distribution and being able to be obtained by a process comprising the stages of: i) polymerization in aqueous solution at a temperature ranging from 70 to 95° C. with an initiation and transfer system comprising: D) an oxidizing agent, E) a reducing agent selected from metabisulphite salts, and preferably from sodium metabisulphite or potassium metabisulphite, the monomers/reducing agent molar ratio not exceeding 50, ii) semi-continuous addition of the oxidizing agent and of the mixture of monomers over a time ranging from 1 to 4 hours, iii) introduction of the reducing agent, either as vessel heel, before the beginning of the addition of the oxidizing agent and of the monomers, or semi-continuously, mixed with the monomers, or semi-continuously, as a separate feed from the latter and from the oxidizing agent. The invention also relates to a specific preparation process and to uses as plasticizer in inorganic hydraulic binder compositions or as dispersing agent in pigment pastes or aqueous polymer dispersions.

The present invention relates to polymeric dispersants which can be used, inter alia, as plasticizers for hydraulic binder compositions, to a specific preparation process and to other uses as dispersants.

The use of plasticizers or dispersants in suspensions of inorganic hydraulic binders, such as cement, is well known and widespread in the industries concerned and in particular in the concrete industry. A category of plasticizers which has become standard in the preparation of cement-based pastes is that of high range water reducers, also known as superplasticizers. These plasticizers or dispersants make it possible to confer, on the paste, a more fluid behaviour than in their absence and to extend this fluidity over time. Furthermore, their use makes it possible to limit the amount of water incorporated in the medium (hence the name “high range water reducers”) during the preparation of the paste comprising the inorganic hydraulic binder, the direct consequence of which is an improvement in the mechanical properties of the final hardened material. These three effects (water reduction, maintenance of rheology and improvement in the mechanical properties of the final material) are today sought in variable proportions depending upon the application to be given to the material based on the inorganic hydraulic binder. The mechanisms of action of these plasticizing molecules have been described in works such as the book edited by Jacques Baron and Jean-Pierre Ollivier, Les betons, Bases et donnees pour leur formulation [Concretes, Bases and Data for their Formulation] (Paris, published by Eyrolles, 1999). From a structural viewpoint, superplasticizers belong to one of the two following chemical families:

A) The Family of the Sulphonated Polymers

The dispersing effect of lignosulphonates has been known for a long time in the concrete industry. For this reason, synthetic polymers with a related structure, such as sulphonated naphthalene formaldehyde condensates (polynaphthalene sulphonate) and sulphonated melamine formaldehyde condensates (polymelamine sulphonate), constitute, even today, a significant part of the superplasticizers used for cement-based binders. However, the dispersing capability of this family of compounds has been greatly exceeded by novel synthetic polymers belonging to a family which has appeared more recently.

B) The Family of the Polycarboxylates

Since about twenty years ago, this family has gradually taken over the market of superplasticizers as it makes it possible to obtain, and by far, the best results in terms of water reduction. In other words, polycarboxylates make possible the greatest fluidities of the cement pastes for a given water to cement (W/C) ratio. Polycarboxylate superplasticizers are branched polymers, the main chain of which comprises carboxyl groups and the longest side chains of which often comprise blocks of polyether type (such as poly(ethylene oxide)). Polycarboxylates owe their very high dispersing effect for inorganic particles to a charged part of their molecule (in alkaline medium, such as that of cement paste) around the main chain and to relatively lengthy nonionic side chains capable of bringing about dispersion by steric repulsion effects.

The most widely used polycarboxylates include those obtained through copolymerization of unsaturated carboxylic acids and of (methoxy)polyethylene glycol (meth)acrylates. Other monomers, such as acrylic esters, styrene, sulphonated monomers or maleic/fumaric derivatives, inter alia, can also form part of the structure of these polycarboxylates.

Whatever their structure, polycarboxylates are generally copolymers (where more than one monomer is used during their synthesis) with a relatively low molecular mass which are soluble or dispersible in water. The control of their molecular mass during the synthesis generally requires the use of a chain transfer agent, which becomes an important ingredient in the polymerization formula. The most widely used transfer agents (also known as chain limiting agents) in radical polymerization are compounds of the thiol family, the —S—H bond being a recognized source of labile hydrogens capable of terminating growing chains while allowing the reinitiation of new chains from the S¹⁰⁸ radical. In point of fact, when polycarboxylate superplasticizers are synthesized by an aqueous solution radical polymerization process, it becomes necessary to use transfer agents with a significant hydrophilicity (indeed even water-soluble transfer agents) which renders them compatible with the process. It is therefore not surprising to find, in the prior art, indications on the use of hydrophilic thiol compounds. Thus, for example, EP 753 488 (Nippon Shokubai & Sandoz) indicates the use of thiols carrying an acid or alcohol functional group. EP 976 769 (Atofina), for its part, claims the use of a specific thiol, mercaptopropyltrimethoxysilane. Transfer agents other than thiols have also been used in the chemical families of the aldehydes (formaldehyde, acetaldehyde, and the like), alcohols (isopropanol, and the like), amines (hydroxylamines, and the like) or phosphorus derivatives (such as H₃PO₂, H₃PO₃, or their salts) but their effectiveness is often lower in comparison with the thiols, hence the need to use combinations of transfer agents so as to limit the mean length of the chains of the superplasticizers to values compatible with the optimum in performance, for example as regards water reduction.

The necessary use of transfer agents to limit the molecular mass (or chain length) of the polycarboxylate copolymers obtained in aqueous solution is not free of disadvantages. Mention may be made, among these, of:
problems of smell conferred on the products, for example during the use of thiols, certain aldehydes or certain amines.
problems of industrial hygiene related to the use of toxic compounds, such as certain thiols, formaldehyde, and the like.
the economic impact on the product, in view of the fact that some of these compounds are expensive and/or have to be used in relatively high proportions. This is the case, for example, with mercaptopropyltrimethoxysilane.
the lack of effectiveness in the control of the molecular masses of certain compounds, which necessitates metering them in a large amount or combining them with other transfer agents, thus complicating the synthetic process.

The Applicant Company has found that it is possible to overcome all these disadvantages, with the other applicational performances at least identical, if not improved, by the use of a system for controlling the molecular masses which is involved simultaneously during the initiation and radical transfer stages, which is one of the subject-matters of the invention, and by the use of a specific process, constituting another subject-matter of the invention. The superplasticizers obtained by using the system for controlling the molecular masses which forms the subject-matter of the invention, according to the specific process which also forms the subject-matter of the invention, exhibit to an outstanding extent an excellent compromise between the three abovementioned effects of high water reduction, maintenance of rheology and final mechanical properties imparted to cement pastes. The polycarboxylate superplasticizers for inorganic hydraulic binders thus obtained also form a subject-matter of the invention.

Thus, the first subject-matter of the invention is a polymeric dispersant, having the performance of a plasticizer or superplasticizer, obtained by a specific process.

The specific process for the preparation of this dispersant is the second subject-matter of the invention.

Another subject-matter of the invention is a dispersant composition comprising at least one dispersant defined according to the invention.

The invention also applies to an aqueous polymer dispersion (latex) comprising at least one dispersant defined according to the invention or obtained according to the process defined according to the invention or present with a composition as defined according to the invention.

The invention also applies to an inorganic hydraulic binder composition, such as cement pastes (grout, mortar, concrete), or an inorganic particle paste composition or a pigment paste composition or an aqueous polymer dispersion composition, these compositions comprising at least one dispersant defined according to the invention.

The use of the dispersants according to the invention as plasticizers for aqueous pastes comprising a hydraulic binder or as dispersants for pigment pastes or for aqueous polymer dispersions also comes within the invention.

Finally, specific preparations based on inorganic hydraulic binders and the hardened items obtained from the latter form part of the invention.

According to an essential element of the invention, the conventional chain transfer agents frequently used for the synthesis of polycarboxylates in an aqueous medium are substituted according to the invention by a system for controlling the molecular masses comprising two types of essential chemical substances, namely: first, an oxidizing agent which produces free radicals and, secondly, a specific reducing agent capable of forming a redox couple with the oxidizing agent and of also functioning, under specific conditions, as a transfer agent (chain limiting agent). This substitution makes it possible to overcome the abovementioned disadvantages associated with the systems for controlling the molecular masses generally used (e.g., mercaptans) for the synthesis of polycarboxylate superplasticizers by radical polymerization in an aqueous medium.

The synthesis of polycarboxylate superplasticizers using this system for controlling molecular masses is carried out according to a specific process for radical polymerization in an aqueous solution which also forms the subject-matter of the invention. This process is characterized, inter alia, by the semi-continuous addition of a feed of monomers and of a feed of oxidizing agent, which feeds are introduced onto a vessel heel in a reactor at the polymerization temperature; depending on the method of introduction chosen for the reducing agent (cf. below), the vessel heel may contain only water or else a dilute aqueous solution of the reducing agent. Another characteristic of this process is specifically the way in which the reducing agent is introduced into the reactor: this is because the latter can be introduced through a semi-continuous feed onto the vessel heel, like the monomers and the oxidizing agent, or else it can be introduced in its entirety into the vessel heel, which, for this reason, is composed of a dilute aqueous solution of reducing agent. When the reducing agent is introduced as a semi-continuous feed, like the oxidizing agent and the monomers, two alternative forms are still possible: it can be introduced in aqueous solution, separately from the other two feeds, or else mixed (dissolved) in the monomers. The introduction of the reducing agent as vessel heel (or as semi-continuous feed) and the simultaneous addition of the feeds of monomer and of oxidizing agent constitute a preferred form of this process as, according to this form and in comparison with other scenarios (e.g., introduction of the oxidizing agent as vessel heel and semi-continuous feeding of the reducing agent and of the monomers), the control of the molecular masses is significantly more effective and the performances of the superplasticizers thus obtained are significantly better, in particular as regards the water reducing effects on cement preparations. Also, among the two possible methods of introduction of the reducing agent, the addition of all of it as vessel heel in the reactor is the preferred method because of its simplicity.

The first subject-matter of the invention is a polymeric dispersant of polycarboxylate type comprising at least one copolymer obtained from a monomer composition comprising:
A) 40 to 95 mol %, preferably 50 to 90 mol %, and more preferably 65 to 80 mol % of units derived from at least one unsaturated carboxylic monomer,
B) 5 to 60 mol %, preferably 10 to 50 mol %, and more preferably 15 to 35 mol % of units derived from at least one acrylic ester or methacrylic ester monomer comprising a polyether chain,
C) 0 to 20 mol %, preferably 0.5 to 10 mol %, and more preferably 1 to 5 mol % of units of at least one third monomer selected from: acrylic ester or methacrylic ester or acrylamide or acrylamide derivative or vinylaromatic monomer or its sulphonated derivative and, preferably, as vinylaromatic, styrene or a sulphonated styrene derivative,
   and with the said copolymer having a controlled molecular mass distribution, which can be obtained by a process comprising the stages of:
i) polymerization in aqueous solution at a temperature ranging from 70 to 95° C., preferably from 70 to 80° C., with an initiation and transfer system comprising:
   D) an oxidizing agent, preferably selected from potassium persulphate, ammonium persulphate or sodium persulphate,
   E) a reducing agent, additionally acting as transfer agent, selected from metabisulphite salts, preferably from sodium metabisulphite or potassium metabisulphite, in the absence of any other transfer agent and in an amount such that the monomers/reducing agent molar ratio does not exceed 50 and preferably does not exceed 40, and more preferably does not exceed 32
ii) semi-continuous addition of the oxidizing agent and of the mixture of monomers over a time ranging from 1 to 4 hours,
iii) introduction of the reducing agent, either as vessel heel, before the beginning of the addition of the oxidizing agent and of the monomers, or semi-continuously, mixed with the monomers, or semi-continuously, as separate feed from the latter and from the oxidizing agent.

The unsaturated carboxylic monomer can be of following general formula: 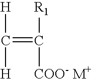
with R₁ being H or CH₃ and M⁺ being a cation selected from: H⁺ (non-neutralized acid form) or ammonium or metal cation from metals belonging to Groups IA and IIA. The preferred unsaturated carboxylic monomer A) is methacrylic acid or acrylic acid and more preferably methacrylic acid. The acrylic ester or methacrylic ester monomer B) comprising a polyether chain can be of general formula: 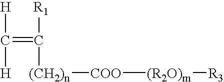
with R₁ being H or CH₃, n being an integer equal to 0, 1 or 2, R₂ being a saturated alkylene group comprising 2, 3 or 4 carbon atoms, m being an integer ranging from 7 to 50 and R₃ being H or a saturated alkyl group comprising 1, 2, 3 or 4 carbon atoms.

The preferred acrylic ester or methacrylic ester monomer B) is methoxypolyethylene glycol methacrylate with the polyether chain comprising methoxy units ranging from 20 to 48.

When the third monomer is present, it can be selected from ethyl acrylate or methyl acrylate or methyl methacrylate or styrene.

The preferred oxidizing agent is ammonium persulphate and the preferred reducing agent is sodium metabisulphite.

The monomers/oxidizing agent molar ratio should preferably not exceed 60, and preferably it varies from 10 to 40, and more preferably it varies from 20 to 40.

The monomers/reducing agent molar ratio should preferably not exceed 40, and preferably it varies from 10 to 40, and more preferably it varies from 16 to 32.

According to particularly preferred conditions, the oxidizing agent is ammonium persulphate and the reducing agent is sodium metabisulphite and the monomers/metabisulphite molar ratio varies from 16 to 32 and the monomers/persulphate molar ratio varies from 20 to 40. The polymerization temperature varies from 70 to 95° C. and preferably from 70 to 80° C.

The second subject-matter of the invention is a process for the preparation of a dispersant as defined according to the invention, which comprises the stages of:
i) polymerization in aqueous solution, at a temperature ranging from 70 to 95° C. and preferably from 70 to 80° C., of a mixture of monomers comprising:
A) 40 to 95 mol %, preferably 50 to 90 mol %, and more preferably 65 to 80 mol % of units derived from at least one unsaturated carboxylic monomer,
B) 5 to 60 mol %, preferably 10 to 50 mol %, and more preferably 15 to 35 mol % of units derived from at least one acrylic ester or methacrylic ester monomer comprising a polyether chain,
C) 0 to 20 mol %, preferably 0.5 to 10 mol %, and more preferably 1 to 5 mol % of units of at least one third monomer selected from: acrylic ester or methacrylic ester or acrylamide or acrylamide derivative or vinylaromatic monomer or its sulphonated derivative and, preferably, as vinylaromatic, styrene or a sulphonated styrene derivative,
   with an initiation and transfer system comprising:
D) an oxidizing agent, preferably selected from potassium persulphate, ammonium persulphate or sodium persulphate,
E) a reducing agent, additionally acting as transfer agent, selected from metabisulphite salts, preferably from sodium metabisulphite or potassium metabisulphite, in the absence of any other transfer agent and in an amount such that the monomers/reducing agent molar ratio does not exceed 50 and preferably does not exceed 40, and more preferably does not exceed 32
ii) semi-continuous addition of the oxidizing agent and of the mixture of monomers over a time ranging from 1 to 4 hours,
iii) introduction of the reducing agent, either as vessel heel, before the beginning of the addition of the oxidizing agent and of the monomers, or semi-continuously, mixed with the monomers, or semi-continuously, as separate feed from the latter and from the oxidizing agent.

The dispersant of the invention can be used as obtained according to the preparation process in an aqueous medium or in the form of a dispersant composition, more particularly an aqueous composition, comprising at least one such dispersant. The solids content by weight of the aqueous solution can range from 5 to 60% and preferably from 30 to 45%.

Another subject-matter of the present invention is an inorganic hydraulic binder composition or inorganic particle paste composition or pigment paste composition or aqueous polymer dispersion composition comprising at least one dispersant as defined according to the invention.

Mention may be made, as hydraulic binder compositions, of: grout (composition formed of water and of cement), mortar (composition formed of water, of cement and of sand) and concrete (composition formed of water, of cement, of sand and of pebbles or aggregates). Mention may be made, as inorganic particles, of: ceramic particles and calcium carbonate. Mention may be made, as suitable pigments for an aqueous pigment paste, of: titanium dioxide and organic pigments.

Inorganic hydraulic binder compositions, such as grout, mortar or concrete, with a water/cement ratio of 0.2 to 1, preferably 0.3 to 0.8, and more preferably 0.5 to 0.6, and a dispersant/cement ratio of 0.05/100 to 20/100 and preferably of 0.05/100 to 15/100 and more particularly of 0.05/100 to 5/100 are more particularly concerned.

Preparations based on inorganic hydraulic binders comprising the dispersants of the invention where the amount of copolymer used, expressed as percentage by dry weight of copolymer with respect to the cement, varies from 0.05 to 15% and preferably from 0.05 to 5% are even more particularly concerned. Such preparations can additionally comprise surfactants, air-detraining additives, antifoaming agents, softeners, setting retarders, setting accelerators, fillers, biocides or other conventional additives.

Another subject-matter of the invention is the use of the dispersants of the invention as plasticizers for aqueous pastes comprising a hydraulic binder, preferably based on cement (grout, mortar, concrete), or as dispersants for pigment pastes or for aqueous polymer or resin dispersions.

A subject-matter of the invention is the hardened articles obtained from hydraulic binder compositions or preparations comprising, as plasticizer, at least one dispersant according to the invention.

The polycarboxylate superplasticizers obtained by using the system for controlling the molecular masses and the polymerization process of the invention are prepared by polymerizing the following monomers:
A) a carboxylic monomer of general formula: 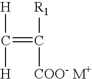
   with R₁ being H or CH₃ and M⁺ being H⁺ (non-neutralized acid form) or a cation belonging to Groups IA and IIA or ammonium,
B) an acrylic ester or methacrylic ester monomer, comprising a polyether side chain, of general formula: 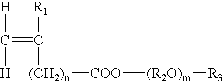
   with R₁ being H or CH₃, n being an integer which can be equal to 0, 1 or 2, R₂ being a saturated alkylene group comprising 2, 3, or 4 carbon atoms, m being an integer of between 7 and 50 and R₃ being H or a saturated alkyl group comprising 1, 2, 3 or 4 carbon atoms,
C) optionally, a third monomer which can be an acrylic ester, a methacrylic ester, acrylamide, an acrylamide derivative, styrene or a sulphonated styrene derivative.

Mention may be made, among the free-radical-producing oxidizing agents D) which are used to initiate the radical polymerization and which constitute the oxidizing agent of the redox couple used to control the molecular masses according to the invention, of persulphates (sodium persulphate, ammonium persulphate or potassium persulphate). The reducing agent E) of the redox couple which makes possible the control of the molecular masses according to the invention is sodium metabisulphite or potassium metabisulphite. In order for the sodium metabisulphite or potassium metabisulphite to effectively play its role in the initiation of the radical polymerization and in the control of the molecular masses, it must have a purity of greater than 96% and preferably of greater than 97%. The oxidizing agent of the redox couple which makes possible the control of the molecular masses should preferably be used in well defined proportions given by the monomers/oxidizing agent molar ratio, which preferably should not exceed the value of 60 and preferably varies from 10 to 40, and more preferably varies from 20 to 40. The reducing agent of this same redox couple should preferably also occur in the polymerization formula in specific proportions given by the monomers/reducing agent ratio which preferably should not exceed the value of 40 and preferably varies from 10 to 40, and more preferably varies from 16 to 32.

The polycarboxylate superplasticizing polymers of the invention are synthesized by polymerization in aqueous solution, the final solids content of which after polymerization can vary from 5 to 60% by weight and preferably from 30 to 45% by weight. The monomers can be mixed before they are introduced into the polymerization reactor. The respective proportions of the three types of monomers mentioned above, A, B and C, can be defined by their molar percentage with respect to the total number of moles of monomer. Thus, the concentrations of the carboxylic monomer (A) must vary from 40 to 95 mol % and preferably from 50 to 90 mol %, and more preferably from 65 to 80 mol %; the acrylic ester or methacrylic ester monomer (B), comprising the polyether side chain, must be present in the formula in concentrations ranging from 5 to 60 mol % and preferably from 10 to 50 mol %, and more preferably from 15 to 35 mol %; the concentrations of the third monomer (C) can vary from 0 to 20 mol % and preferably from 0.5 to 10 mol %, and more preferably from 1 to 5 mol %.

The polymerization process which constitutes one of the subject-matters of the invention takes place as follows as regards the form with the reducing agent in the vessel heel:
1) the reactor is charged with demineralized water and is heated to a polymerization temperature ranging from 70 to 95° C. and preferably from 70 to 80° C. This temperature, which will be kept constant, is one of the important points of the process. This temperature range contrasts with the usual polymerization temperatures when the persulphate/metabisulphite couple is used, as in Patent Application EP 753 488 (Nippon Shokubai & Sandoz), where the polymerization temperature must be kept at lower values (preferably between 20 and 52° C.). During this time, a mixture of the monomers of type A and B (optionally C) is prepared, as are aqueous solutions of the oxidizing agent (persulphate) and of the reducing agent (metabisulphite).
2) All of the solution of reducing agent is added to the reactor containing demineralized water (vessel heel) at the polymerization temperature and the addition to the reactor of separate feeds of the mixture of monomers and of 80% by weight of the aqueous solution of oxidizing agent is begun. The presence of all of the reducing agent in the reactor at the polymerization temperature at the moment of the beginning of the addition of the monomers and of the oxidizing agent is a very important point of the process according to the invention as this makes it possible to obtain superplasticizing copolymers having a very good compromise in performance.
3) The semi-continuous feeding of the monomers and of the solution of oxidizing agent (80% by weight of the total of the solution of oxidizing agent prepared) to the reactor is maintained for a time ranging from 1 to 4 hours and preferably from 1.5 to 3 hours. On completion of the addition, the reaction medium is left heating for 15 minutes.
4) On completion of the 15 minutes after the end of the addition of the monomers, the remaining 20% by weight of the solution of oxidizing agent is added all at once to the reactor and heating is maintained for an additional 45 minutes.
5) On completion of the 45 minutes, as indicated above, the copolymer solution is cooled and optionally neutralized with a water-soluble alkaline agent, such as sodium hydroxide, potassium hydroxide, ammonia, and the like, so as to adjust the pH of the solution to a value close to 6 or 7.
   Measurements of the Performances of the Products:

The performances of the products are determined by tests carried out on model grout (cement+water), mortar (cement+sand+water) or concrete (cement+fine and coarse aggregates+water) formulations. These test formulations are generally simplified as much as possible so that additives often used for the final applications, such as biocides, inert fillers, surfactants, air-detraining agents, setting retarders or setting accelerators, are excluded without this in any way compromising the validity of the evaluation. Furthermore, the latter is always carried out comparatively (e.g., with respect to a commercial product or a known product).

The evaluation test which is most widely used by a person skilled in the art of cement-based hydraulic binders is the slump test, which is a measurement of the spreading of a cement preparation (grout, mortar or concrete). The greater the spreading of the preparation, the more fluid the preparation. Fluidity can be obtained for a given type of cement by the addition of: 1) more water, which implies a higher water/cement, W/C, ratio; 2) more superplasticizer, which implies a higher level of superplasticizer with respect to the cement (% by weight). At a fixed W/C and at a fixed percentage of superplasticizer, a superplasticizer is a better water reducer if the spreading in the slump test is greater than that of the reference. At a constant slump test spreading, a superplasticizer is a better water reducer than the reference if the W/C ratio and/or the percentage by weight used in the cement preparation are lower than those used with the reference. The test can be repeated at often regular intervals so as to determine the change in the spreading over time. Generally, this change is monitored over a period of 2 hours, during which the less the spreading decreases (or the less it rapidly decreases), the more the superplasticizer used provides good maintenance of rheology.

Test specimens are often prepared with the cement preparation under study so as to monitor, after setting, their mechanical behaviour, determined by the compressive force necessary for their failure.

The control of the molecular masses of superplasticizing copolymers can be confirmed by measurements of molecular masses and of molecular mass distributions according to techniques well known in the science of polymers. These include steric exclusion chromatography (SEC), also known as gel permeation chromatography (GPC). This is a technique which, once mastered for a given system, makes possible rapid monitoring of molecular masses and of molecular mass distributions.

The examples below illustrate the invention without limiting the scope thereof:

### EXAMPLE 1

### Invention

108 g of demineralized water are charged to a polymerization reactor equipped with a jacket, which makes possible the circulation of a heat-transfer fluid for heating/cooling the system, with a branch connection, which makes possible the introduction of a probe for measuring the temperature of the medium, with a branch connection, which makes possible the introduction of gaseous nitrogen to drive off the oxygen which inhibits the polymerization reaction, with a stirrer connected to a motor, which makes possible rotation at variable speed, with two inlets, which make possible the addition of additives, and with an outlet for vapours connected to a condensation/reflux system. The reactor is heated so that the medium reaches a temperature of 55° C. and, at this point, a stream of nitrogen is released by sparging into the demineralized water. Sparging is maintained for 30 minutes and with moderate stirring, while allowing the temperature of the medium to rise to the target value of 75° C. During the degassing with nitrogen, the following two mixtures are prepared:
1) Aqueous solution of oxidizing agent: 2.28 g of ammonium persulphate (Aldrich) are dissolved in 20.52 g of demineralized water in a suitable receptacle.
2) Mixture of monomers and reducing agent: 1.76 g of methacrylic acid (Atofina) are mixed with 365.23 g of Norsocryl N402 (Atofina) [methoxypolyethylene glycol methacrylate monomer with a side chain of 2 000 g/mol on average of poly(ethylene oxide) units comprising 3.05% by weight of methacrylic acid, which is taken into account in calculating the molar ratios, and 40% by weight of water, which is taken into account in the adjustment of the final solids content] and 1.48 g of sodium metabisulphite, with a purity equal to or greater than 98% (Prolabo), in a suitable receptacle.

When the thirty minutes of degassing have passed and when the temperature of the reactor is 75° C., feeding of the aqueous solution of ammonium persulphate and of the mixture of monomers and reducing agent to the reactor is initiated using two metering pumps, the flow rate of which is adjusted in order for all of the mixture of monomers (368.47 g) and 80% (by weight) of the aqueous solution of oxidizing agent (18.24 g of solution) to be fed to the reactor over a time of 2 hours 30 minutes. Sparging with nitrogen and stirring are maintained. Vigorous stirring is also maintained in the receptacle containing the monomers/reducing agent mixture, in order to limit the reaction (premature) between the reducing agent and the oxygen dissolved in the mixture. On completion of the feeding (2 h 30), the medium is left heating at 75° C. for 15 minutes before adding, all at once, the remainder (20% by weight) of the aqueous solution of ammonium persulphate (4.56 g of solution). After the addition of the remainder of the solution of oxidizing agent, the temperature is maintained with the reactor under nitrogen and stirring for an additional 45 minutes. On completion of this latter heating, the medium is cooled and the nitrogen is cut off. The polycarboxylate copolymer solution thus obtained is discharged from the reactor at a temperature of <40° C. The solids content, determined by gravimetric analysis, is 45.5% [100×(dry weight/weight of solution)].

Measurement of the Spreading as a Function of Time on a Model Mortar:

The superplasticizer solution is treated with 1% of Clerol antifoaming agent with respect to the solids content.

The values of W/C and of % by weight of superplasticizer (with respect to the cement) are set respectively at 0.54 and 0.175%.

518.5 g of dry cement of Lumbres type, 1 350 g of standard sand (CEN EN 196-1), 1.994 g of aqueous solution of superplasticizer and 278.90 g of drinking water (account taken of the water present in the superplasticizer solution) are weighed out.

The water and the superplasticizer solution are mixed (mixing water). The mixing water is introduced into a mechanical mixer for mortar, the cement is then added and mixing is carried out at 65 revolutions/minute for 30 seconds. The sand is subsequently added and mixing is continued for a further 30 seconds at 65 revolutions/minute. Mixing of the combined mixture is continued for 30 seconds at 125 revolutions/minute, after which the preparation is left standing for 90 seconds before again mixing for 60 seconds at 125 revolutions/minute.

This preparation is used to fill an Abrams mini cone, the characteristics of which are as follows:

| | | |
|---|---|---|
| minimum weight: | 4 | kg |
| Top diameter: | 50 | mm |
| Bottom diameter: | 100 | mm |
| Height: | 150 | mm |

The cone is placed on a 50×50 cm PVC sheet with a thickness of 1 cm moistened using a sponge.

Filling is carried out in three installments (⅓ of the height on each occasion) and lasts a total of 2 minutes. At the end of each filling stage, the contents of the cone are tamped down by “poking” the preparation inside the cone 25 times using a metal rod with a length of 30 cm and a diameter of 5 mm. This operation makes it possible to remove air bubbles.

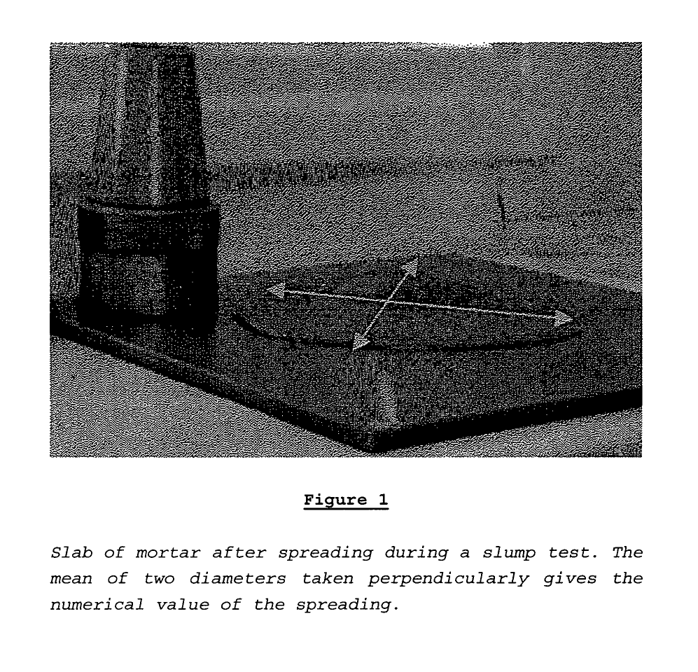

Exactly 2 minutes after the beginning of filling, the cone is raised and its contents spread out over the PVC sheet. After 30 seconds, the spreading is determined by measuring the length in mm of two perpendicular diameters of the round slab of mortar and by taking the mean of the two diameters (cf. FIG. 1). As regards measurements of spreading as a function of time, the preparation is recovered after spreading and is returned to the mixer, where it is left standing and covered (to prevent the evaporation of water) until the time of the following measurement. Before filling the cone again, the preparation is mixed at 125 revolutions/minute for 60 seconds. The tests are carried out in a climate-controlled chamber, the temperature of which is kept constant at 21° C. (tolerance of plus or minus 2 degrees).

The change over time in the spreading corresponding to the mortar preparation comprising the superplasticizer of the example is presented in Table I.

The distribution in the molecular masses of the copolymer of this example was determined by steric exclusion chromatography (SEC) using a Waters aqueous SEC line composed of a Waters 510 pump equipped with 610° heads with an output of 0.800 ml/min. The eluent was Biosolve HPLC water with the addition of lithium nitrate (Merck), filtered at 0.45 microns and degassed with helium. The separation columns are TSK PW XL columns: 2 500 precolumn and then 6 000, 2 500, 3 000 and 4 000 columns placed in a Jasco Pelletier-effect oven adjusted to 35° C. The injection is carried out via a Rheodyne type 7125 valve with central injection equipped with a 20 microlitre loop. Detection is carried out via an Erma/Varian RI 4 refractometer and, in double detection mode, a Jasco Uvilec 100 V, known as Varian 2050, UV ultraviolet detector is also used at a wavelength of 254 nm. The signal is processed by a data processing system which makes it possible, using the PL Caliber 7.01 software from Polymer Laboratories, to access the average molar masses. The molar masses are calculated using a calibration curve drawn up with polyethylene glycol, PEG, standards. The figures given are therefore all in PEG equivalents. The values of the average molecular masses of the copolymer of this example are shown in Table IV.

The mechanical properties of the mortars obtained with the superplasticizer of this example were determined in a compressive test on c. 500 g test specimens at 24 hours and at 7 days from the preparation of the test specimens. The mortar used was manufactured according to the following formula: 515 g of CPA 42.5 R CP2 cement from Lumbres, 150 g of a Tacon P2 limestone filler, 1 350 g of 0/4 standard sand from GEM and a water/cement ratio of 0.583. The evaluation was carried out with respect to a commercial reference (Glenium 27 from MBT) with a level of superplasticizer of 0.176% by weight with respect to the cement for the product from Example 1 and of 0.203% by weight for the reference. The mechanical compressive strength of the mortar test specimens which are obtained with the superplasticizer of this example is presented in Table V.

### EXAMPLE 2

### Invention

90 g of demineralized water are charged to a polymerization reactor equipped with a jacket, which makes possible the circulation of a heat-transfer fluid for heating/cooling the system, with a branch connection, which makes possible the introduction of a probe for measuring the temperature of the medium, with a branch connection, which makes possible the introduction of gaseous nitrogen to drive off the oxygen which inhibits the polymerization reaction, with a stirrer connected to a motor, which makes possible rotation of variable speed, with two inlets, which make possible the addition of additives, and with an outlet for vapours connected to a condensation/reflux system. The reactor is heated so that the medium reaches a temperature of 55° C. and, at this point, a stream of nitrogen is released by sparging into the demineralized water. Sparging is maintained for 30 minutes and with moderate stirring, while allowing the temperature of the medium to rise to the target value of 75° C. During the degassing with nitrogen, the following three mixtures are prepared:
1) Aqueous solution of reducing agent: 1.48 g of sodium metabisulphite, with a purity of greater than or equal to 98% (Prolabo), are dissolved in 18 g of demineralized water in a suitable receptacle.
2) Aqueous solution of oxidizing agent: 2.28 g of ammonium persulphate (Aldrich) are dissolved in 20.52 g of demineralized water in a suitable receptacle.
3) Mixture of monomers: 1.76 g of methacrylic acid (Atofina) are mixed with 365.23 g of Norsocryl N₄O₂ (Atofina) (methoxypolyethylene glycol methacrylate monomer with a side chain of 2 000 g/mol on average of poly(ethylene oxide) units) (regarding the composition considered: see comment in Example 1) in a suitable receptacle.

When the thirty minutes of degassing have passed and when the temperature of the reactor is 75° C., all of the aqueous sodium metabisulphite solution is added to the reactor. At the same time, feeding of the aqueous ammonium persulphate solution and of the mixture of monomers to the reactor is initiated using two metering pumps, the flow rate of which is adjusted in order for all of the mixture of monomers (366.99 g) and 80% (by weight) of the aqueous solution of oxidizing agent (18.24 g of solution) to be fed to the reactor over a time of 2 hours 30 minutes. Sparging with nitrogen and stirring are maintained. On completion of the feeding (2 h 30), the medium is left heating at 75° C. for 15 minutes before adding, all at once, the remainder (20% by weight) of the aqueous solution of ammonium persulphate (4.56 g of solution). After the addition of the remainder of the solution of oxidizing agent, the temperature is maintained with the reactor under nitrogen and stirring for an additional 45 minutes. On completion of this final heating, the medium is cooled and the nitrogen is cut off. The polycarboxylate copolymer solution thus obtained is discharged from the reactor at a temperature of <40° C. The solids content, determined by gravimetric analysis, is 44.3%.

Measurement of the Spreading as a Function of Time on a Model Mortar:

The conditions relating to the antifoaming agent and the W/C ratios are the same as for the evaluation of Example 1.

In this instance, 518.5 g of dry cement of Lumbres type, 1 350 g of standard sand (CEN EN 196-1), 2.048 g of aqueous solution of superplasticizer and 279.08 g of drinking water (account taken of the water present in the superplasticizer solution) are weighed out.

The measurements of the change in the spreading with time are carried out as described in Example 1 and appear in Table I.

The distribution in the molecular masses of the copolymer of this example was determined by steric exclusion chromatography (SEC) according to the technique described above (Example 1). The average molar masses thus determined appear in Table IV.

### EXAMPLE 3

### Invention

The method of preparation described in Example 1 is followed, except that the aqueous solution of oxidizing agent is prepared with 2.44 g of ammonium persulphate (Aldrich) in 21.95 g of demineralized water and the mixture of monomers and reducing agent is prepared with 3.45 g of methacrylic acid (Atofina), 361.72 g of Norsocryl N₄O₂ (Atofina) and 1.59 g of sodium metabisulphite with a purity equal to or greater than 98% (Prolabo).

When the thirty minutes of degassing have passed and when the temperature of the reactor is 75° C., feeding of the aqueous solution of ammonium persulphate and of the mixture of monomers and reducing agent to the reactor is initiated using 2 metering pumps, the flow rate of which is adjusted in order for all of the mixture of monomers (366.76 g) and 80% (by weight) of the aqueous solution of oxidizing agent (19.51 g of solution) to be fed to the reactor over a time of 2 hours 30 minutes. Sparging with nitrogen and stirring are maintained. Vigorous stirring is also maintained in the receptacle containing the monomers/reducing agent mixture, in order to limit the reaction (premature) between the reducing agent and the oxygen dissolved in the mixture. On completion of the feeding (2 h 30), the medium is left heating at 75° C. for 15 minutes before adding, all at once, the remainder (20% by weight) of the aqueous solution of ammonium persulphate (4.88 g of solution). The addition of the remainder of the solution of oxidizing agent and the continuation are carried out under the conditions already described in Example 1. The solids content is 44.3%.

Measurement of the Spreading as a Function of Time on a Model Mortar:

Antifoaming agent and W/C conditions: identical to Example 1.

518.5 g of dry cement of Lumbres type, 1 350 g of standard sand (CEN EN 196-1), 2.048 g of aqueous solution of superplasticizer and 278.85 g of drinking water (account taken of the water present in the superplasticizer solution) are weighed out.

The spreading measurements are carried out as described in Example 1 and are presented in Table I.

### EXAMPLE 4

### Invention

The procedure described in Example 2 is followed, except that the aqueous solution of reducing agent is prepared with 2.03 g of sodium metabisulphite, with a purity of greater than or equal to 98% (Prolabo), in 18 g of demineralized water, the aqueous solution of oxidizing agent is prepared with 2.44 g of ammonium persulphate (Aldrich) in 21.95 g of demineralized water and the mixture of monomers is prepared with 3.45 g of methacrylic acid (Atofina) and 361.72 g of Norsocryl N402 (Atofina).

When the thirty minutes of degassing have passed and when the temperature of the reactor is 75° C., all of the aqueous sodium metabisulphite solution is added to the reactor. At the same time, feeding of the aqueous ammonium persulphate solution and of the mixture of monomers to the reactor is initiated using two metering pumps, the flow rate of which is adjusted in order for all of the mixture of monomers (365.17 g) and 80% (by weight) of the aqueous solution of oxidizing agent (19.51 g of solution) to be fed to the reactor over a time of 2 hours 30 minutes. Sparging with nitrogen and stirring are maintained. On completion of the feeding (2 h 30), the medium is left heating at 75° C. for 15 minutes before adding, all at once, the remainder (20% by weight) of the aqueous solution of ammonium persulphate (4.88 g of solution). Continuation and end according to Example 1. The solids content is 45.2%.

Measurement of the Spreading as a Function of Time on a Model Mortar:

Antifoaming agent and W/C conditions: identical to Example 1.

518.5 g of dry cement of Lumbres type, 1 350 g of standard sand (CEN EN 196-1), 2.007 g of aqueous solution of superplasticizer and 278.89 g of drinking water (account taken of the water present in the superplasticizer solution) are weighed out.

The change in the spreading as a function of time is monitored according to the method described in Example 1 and the results are presented in Table I.

The mechanical properties of the mortars obtained with the superplasticizer of this example were determined in a compressive test on c. 500 g test specimens at 24 hours and at 7 days from the preparation of the test specimens. The mortar used was manufactured according to the following formula: 515 g of Heming 42.5 R cement, 150 g of Tacon P2 limestone filler, 1 350 g of R Millery 0/4 standard sand and a water/cement ratio of 0.58. The evaluation was carried out with a level of superplasticizer of 0.2% by weight with respect to the cement. The mechanical compressive strength of the mortar test specimens which are obtained with the superplasticizer of this example is presented in Table VI.

### EXAMPLE 5

### Invention

The procedure described in Example 2 is followed, except that the aqueous solution of reducing agent is prepared with 1.69 g of sodium metabisulphite, with a purity of greater than or equal to 98% (Prolabo), in 18 g of demineralized water, the aqueous solution of oxidizing agent is prepared with 2.59 g of ammonium persulphate (Aldrich) in 23.35 g of demineralized water and the mixture of monomers is prepared with 5.1 g of methacrylic acid (Atofina) and 358.21 g of Norsocryl N402 (Atofina).

The conditions preceding the feeding of the oxidizing agent and monomers are identical to those of Example 2: 75° C. and all of the reducing agent in the vessel heel. The feeding to the reactor of the aqueous ammonium persulphate solution and of the mixture of monomers is begun using 2 metering pumps, the flow rate of which is adjusted in order for all of the mixture of monomers (363.31 g) and 80% (by weight) of the aqueous solution of oxidizing agent (20.75 g of solution) to be fed to the reactor over a time of 2 hours 30 minutes. Sparging with nitrogen and stirring are maintained. On completion of the feeding (2 h 30), the medium is left heating at 75° C. for 15 minutes before adding, all at once, the remainder (20% by weight) of the aqueous ammonium persulphate solution (5.19 g of solution). Conditions for continuing the preparation according to Example 1. The solids content measured is 44.3%.

Measurement of the Spreading as a Function of Time on a Model Mortar:

Antifoaming agent and W/C conditions: identical to Example 1.

518.5 g of dry cement of Lumbres type, 1 350 g of standard sand (CEN EN 196-1), 2.048 g of aqueous solution of superplasticizer and 279.08 g of drinking water (account taken of the water present in the superplasticizer solution) are weighed out.

The spreading measurements are carried out as described in Example 1 and are presented in Table I.

The mechanical properties of the mortars obtained with the superplasticizer of this example were determined in a compressive test on c. 500 g test specimens at 24 hours and at 7 days from the preparation of the test specimens. The mortar used was manufactured according to the following formula: 515 g of Heming 42.5 R cement, 150 g of Tacon P2 limestone filler, 1 350 g of R Millery 0/4 standard sand and a water/cement ratio of 0.58. The evaluation was carried out with a level of superplasticizer of 0.25% by weight with respect to the cement. The mechanical compressive strength of the mortar test specimens which are obtained with the superplasticizer of this example is presented in Table VI.

### EXAMPLE 6

### Invention

The procedure described in Example 2 is followed, except that the aqueous solution of reducing agent is prepared with 2.1 g of sodium metabisulphite, with a purity of greater than or equal to 98% (Prolabo), in 18 g of demineralized water, the aqueous solution of oxidizing agent is prepared with 3.2 g of ammonium persulphate (Aldrich) in 28.76 g of demineralized water and the mixture of monomers is prepared with 11.44 g of methacrylic acid (Atofina) and 345.92 g of Norsocryl N402 (Atofina).

The preparation conditions are identical to those of Example 2 but with a different composition with a mixture of monomers of 357.36 g and 80% (by weight) of the aqueous solution of oxidizing agent (25.57 g of solution). The final solids content measured is 45.7%.

Measurement of the Initial Spreading on a Model Mortar:

Antifoaming agent: conditions of Example 1.

The values of W/C and of % by weight of superplasticizer (with respect to the cement) are set respectively at 0.466 and 0.175%.

518.5 g of dry cement of Altkirch type, 1 350 g of standard sand (CEN EN 196-1), 1.986 g of aqueous solution of superplasticizer and 240.54 g of drinking water (account taken of the water present in the superplasticizer solution) are weighed out.

The initial spreading measurement is carried out as described in Example 1.

A comparison of the initial spreadings corresponding to the mortar preparations of Examples 6 to 10, with respect to that of a reference preparation prepared with a commercial superplasticizer known to be a high water reducer (MBT), is presented in Table II.

### EXAMPLE 7

### Invention

The procedure described in Example 2 is followed, except that the aqueous solution of reducing agent is prepared with 2.17 g of sodium metabisulphite, with a purity of greater than or equal to 98% (Prolabo), in 18 g of demineralized water, the aqueous solution of oxidizing agent is prepared with 3.33 g of ammonium persulphate (Aldrich) in 30.01 g of demineralized water and the mixture of monomers is prepared with 12.94 g of methacrylic acid (Atofina) and 342.41 g of Norsocryl N402 (Atofina).

The preparation conditions are identical to those of Example 2 but with a different composition (see above) with a mixture of monomers of 355.35 g and 80% (by weight) of solution of oxidizing agent (26.67 g of solution).

The final solids content, measured by gravimetric analysis, is 45.9%.

Measurement of the Initial Spreading on a Model Mortar:

Antifoaming agent and W/C conditions: identical to Example 6.

518.5 g of dry cement of Altkirch type, 1 350 g of standard sand (CEN EN 196-1), 1.977 g of aqueous solution of superplasticizer and 240.55 g of drinking water (account taken of the water present in the superplasticizer solution) are weighed out.

The initial spreading measurement is carried out as described in Example 1. The results are presented in Table II.

### EXAMPLE 8

### Invention

The procedure described in Example 2 is followed, except that the aqueous solution of reducing agent is prepared with 2.27 g of sodium metabisulphite, with a purity of greater than or equal to 98% (Prolabo), in 18 g of demineralized water, the aqueous solution of oxidizing agent is prepared with 3.49 g of ammonium persulphate (Aldrich) in 31.39 g of demineralized water and the mixture of monomers is prepared with 14.48 g of methacrylic acid (Atofina) and 340.65 g of Norsocryl N402 (Atofina).

The preparation conditions are identical to those of Example 2 but with a different composition (see above) with a mixture of monomers of 355.13 g and 80% (by weight) of the aqueous solution of oxidizing agent (27.90 g of solution). The final solids content, measured by gravimetric analysis, is 46.0%.

Measurement of the Initial Spreading on a Model Mortar:

Antifoaming agent and W/C conditions: identical to Example 6.

518.5 g of dry cement of Altkirch type, 1 350 g of standard sand (CEN EN 196-1), 1.973 g of aqueous solution of superplasticizer and 240.56 g of drinking water (account taken of the water present in the superplasticizer solution) are weighed out.

The initial spreading measurement is carried out as described in Example 1. The results are presented in Table II.

### EXAMPLE 9

### Invention

The procedure described in Example 2 is followed, except that the aqueous solution of reducing agent is prepared with 2.36 g of sodium metabisulphite, with a purity of greater than or equal to 98% (Prolabo), in 18 g of demineralized water, the aqueous solution of oxidizing agent is prepared with 3.62 g of ammonium persulphate (Aldrich) in 32.58 g of demineralized water and the mixture of monomers is prepared with 15.91 g of methacrylic acid (Atofina) and 337.14 g of Norsocryl N402 (Atofina).

The preparation conditions are identical to those of Example 2 but with a different composition (see above) with a mixture of monomers of 353.05 g and 80% (by weight) of the solution of oxidizing agent (28.96 g of solution). The final solids content, measured by gravimetric analysis, is 44.4%.

Measurement of the Initial Spreading on a Model Mortar:

Antifoaming agent and W/C conditions: identical to Example 6.

518.5 g of dry cement of Altkirch type, 1 350 g of standard sand (CEN EN 196-1), 2.044 g of aqueous solution of superplasticizer and 240.48 g of drinking water (account taken of the water present in the superplasticizer solution) are weighed out.

The initial spreading measurement is carried out as described in Example 1. The results are presented in Table II.

### EXAMPLE 10

### Invention

The procedure described in Example 2 is followed, except that the aqueous solution of reducing agent is prepared with 2.44 g of sodium metabisulphite, with a purity of greater than or equal to 98% (Prolabo), in 18 g of demineralized water, the aqueous solution of oxidizing agent is prepared with 3.75 g of ammonium persulphate (Aldrich) in 33.74 g of demineralized water and the mixture of monomers is prepared with 17.32 g of methacrylic acid (Atofina) and 333.63 g of Norsocryl N402 (Atofina).

The preparation conditions are identical to those of Example 2 but with a different composition (see above) with a mixture of monomers of 350.95 g and 80% (by weight) of the aqueous solution of oxidizing agent of 29.99 g. The final solids content, measured by gravimetric analysis, is 43.6%.

Measurement of the Initial Spreading on a Model Mortar:

Antifoaming agent and W/C conditions: identical to Example 6.

518.5 g of dry cement of Altkirch type, 1 350 g of standard sand (CEN EN 196-1), 2.081 g of aqueous solution of superplasticizer and 240.45 g of drinking water (account taken of the water present in the superplasticizer solution) are weighed out.

The initial spreading measurement is carried out as described in Example 1. The results are presented in Table II.

### EXAMPLE 11

### Invention

The procedure described in Example 2 is followed, except that the aqueous solution of reducing agent is prepared with 1.98 g of potassium metabisulphite, in 29.79 g of demineralized water, the aqueous solution of oxidizing agent is prepared with 2.60 g of ammonium persulphate (Aldrich) in 29.88 g of demineralized water and the mixture of monomers is prepared with 1.3 g of methacrylic acid (Atofina) and 440.45 g of Norsocryl N₄O₂ (Atofina).

The preparation conditions are identical to those of Example 2 but with a different composition (see above) with a mixture of monomers of 441.75 g and 80% (by weight) of the solution of oxidizing agent (25.98 g of solution). The final solids content, measured by gravimetric analysis, is 45.4%, and the Brookfield viscosity is 294 mPa.s.

Measurement of the Initial Spreading on a Model Mortar:

Antifoaming agent and W/C conditions: identical to Example 1.

518.5 g of dry cement of Lumbres type, 1350 g of standard sand (CEN EN 196-1), 2.048 g of aqueous solution of superplasticizer and 279.08 g of drinking water (account taken of the water present in the superplasticizer solution) are weighed out.

The initial spreading measurement is carried out as described in Example 1. The results are presented in Table VII.

### EXAMPLE 12

### Invention

The procedure described in Example 11 is followed, except that the aqueous solution of reducing agent is prepared with sodium metabisulphite.

### COUNTEREXAMPLE 1

### Comparative

108 g of demineralized water are charged to a polymerization reactor equipped with a jacket, which makes possible the circulation of a heat-transfer fluid for heating/cooling the system, with a branch connection, which makes possible the introduction of a probe for measuring the temperature of the medium, with a branch connection, which makes possible the introduction of gaseous nitrogen to drive off the oxygen which inhibits the polymerization reaction, with a stirrer connected to a motor, which makes possible rotation at variable speed, with two inlets, which make possible the addition of additives, and with an outlet for vapours connected to a condensation/reflux system. The reactor is heated so that the medium reaches a temperature of 55° C. and, at this point, a stream of nitrogen is released by sparging into the demineralized water. Sparging is maintained for 30 minutes and with moderate stirring, while allowing the temperature of the medium to rise to the target value of 75° C. During the degassing with nitrogen, the following two mixtures are prepared:
1) Aqueous solution of oxidizing agent: 1.56 g of ammonium persulphate (Aldrich) are dissolved in 14.08 g of demineralized water in a suitable receptacle.
2) Mixture of monomers and of transfer agent (mercaptan): 1.79 g of methacrylic acid (Atofina) are mixed with 372.26 g of Norsocryl N₄O₂ (Atofina) [methoxypolyethylene glycol methacrylate monomer with a side chain of 2 000 g/mol on average of poly(ethylene oxide) units] and 1.66 g of mercaptoethanol (Aldrich) in a suitable receptacle.

When the thirty minutes of degassing have passed and when the temperature of the reactor is 75° C., feeding of the aqueous solution of ammonium persulphate and of the mixture of monomers and of transfer agent to the reactor is initiated using 2 metering pumps, the flow rate of which is adjusted in order for all of the mixture of monomers (375.71 g) and 80% (by weight) of the aqueous solution of oxidizing agent (12.51 g of solution) to be fed to the reactor over a time of 2 hours 30 minutes. Sparging with nitrogen and stirring are maintained. On completion of the feeding (2 h 30), the medium is left heating at 75° C. for 15 minutes before adding, all at once, the remainder (20% by weight) of the aqueous solution of ammonium persulphate (3.13 g of solution). After the addition of the remainder of the solution of oxidizing agent, the temperature is maintained with the reactor under nitrogen and stirring for an additional 45 minutes. On completion of this latter heating, the medium is cooled and the nitrogen is cut off. The polycarboxylate copolymer solution thus obtained is discharged from the reactor at <40° C. The solids content, determined by gravimetric analysis, is 45.3%. The solution thus obtained has a marked smell of sulphur.

Measurement of the Spreading as a Function of Time on a Model Mortar:

The superplasticizer solution is treated with 1% of Clerol antifoaming agent with respect to the solids content.

The values of W/C and of % by weight of superplasticizer (with respect to the cement) are set respectively at 0.55 and 0.175%.

518.5 g of dry cement of Lumbres type, 1 350 g of standard sand (CEN EN 196-1), 2.003 g of aqueous solution of superplasticizer and 284.08 g of drinking water (account taken of the water present in the superplasticizer solution) are weighed out.

The spreading measures are carried out as described in Example 1.

The change over time in the spreading corresponding to the mortar preparation comprising the superplasticizer of this example is presented in Table I. It should be noted that the preparation of Counterexample 1 is obtained with a higher W/C ratio, which places it even further below the performances of Examples 1-5.

### COUNTEREXAMPLE 2

### Comparative

The method of preparation described in Example 1 is followed, except that the aqueous solution of oxidizing agent is prepared with 2.29 g of ammonium persulphate (Aldrich) in 20.62 g of demineralized water and the mixture of monomers and reducing agent is prepared with 1.77 g of methacrylic acid (Atofina), 366.99 g of Norsocryl N₄O₂ (Atofina) and 0.8 g of sodium metabisulphite with a purity equal to or greater than 98% (Prolabo).

When the thirty minutes of degassing have passed and when the temperature of the reactor is 75° C., feeding of the aqueous solution of ammonium persulphate and of the mixture of monomers and reducing agent to the reactor is initiated using two metering pumps, the flow rate of which is adjusted in order for all of the mixture of monomers (369.56 g) and 80% (by weight) of the aqueous solution of oxidizing agent (18.33 g of solution) to be fed to the reactor over a time of 2 hours 30 minutes. Sparging with nitrogen and stirring are maintained. Vigorous stirring is also maintained in the receptacle containing the monomers/reducing agent mixture, in order to limit the reaction (premature) between the reducing agent and the oxygen dissolved in the mixture. On completion of the feeding (2 h 30), the medium is left heating at 75° C. for 15 minutes before adding, all at once, the remainder (20% by weight) of the aqueous solution of ammonium persulphate (4.58 g of solution). After the addition of the remainder of the solution of oxidizing agent, the temperature is maintained with the reactor under nitrogen and stirring for an additional 45 minutes. On completion of this latter heating, the medium is cooled and the nitrogen is cut off. The polycarboxylate copolymer solution thus obtained is discharged from the reactor at <40° C. The solids content, determined by gravimetric analysis, is 45.0%.

Measurement of the Spreading as a Function of Time on a Model Mortar:

The superplasticizer solution is treated with 1% of Clerol antifoaming agent with respect to the solids content.

The values of W/C and of % by weight of superplasticizer (with respect to the cement) are set respectively at 0.53 and 0.175%.

518.5 g of dry cement of Lumbres type, 1 350 g of standard sand (CEN EN 196-1), 2.016 g of aqueous solution of superplasticizer and 273.70 g of drinking water (account taken of the water present in the superplasticizer solution) are weighed out.

The change over time in the spreading corresponding to the mortar preparation comprising the superplasticizer of this example is presented in Table III. The reference is the product of Example 1 with a W/C ratio of 0.53.

The distribution in the molecular masses of the copolymer of this example was determined by steric exclusion chromatography (SEC) according to the technique described above (Example 1). The average molar masses thus determined appear in Table IV.

### COUNTEREXAMPLE 3

### Comparative

90 g of demineralized water are charged to a polymerization reactor equipped with a jacket, which makes possible the circulation of a heat-transfer fluid for heating/cooling the system, with a branch connection, which makes possible the introduction of a probe for measuring the temperature of the medium, with a branch connection, which makes possible the introduction of gaseous nitrogen to drive off the oxygen which inhibits the polymerization reaction, with a stirrer connected to a motor, which makes possible rotation of variable speed, with two inlets, which make possible the addition of additives, and with an outlet for vapours connected to a condensation/reflux system. The reactor is heated so that the medium reaches a temperature of 55° C. and, at this point, a stream of nitrogen is released by sparging into the demineralized water. Sparging is maintained for 30 minutes and with moderate stirring, while allowing the temperature of the medium to rise to the target value of 75° C. During the degassing with nitrogen, the following three mixtures are prepared:
1) Aqueous solution of reducing agent: 1.48 g of sodium metabisulphite, with a purity of greater than or equal to 98% (Prolabo), are dissolved in 18 g of demineralized water in a suitable receptacle.
2) Aqueous solution of oxidizing agent: 2.28 g of ammonium persulphate (Aldrich) are dissolved in 20.52 g of demineralized water in a suitable receptacle.
3) Mixture of monomers: 1.76 g of methacrylic acid (Atofina) are mixed with 365.23 g of Norsocryl N402 (Atofina) (methoxypolyethylene glycol methacrylate monomer with a side chain of 2 000 g/mol on average of poly(ethylene oxide) units) in a suitable receptacle.

When the thirty minutes of degassing have passed and when the temperature of the reactor is 75° C., all of the aqueous ammonium persulphate solution is added to the reactor. At the same time, feeding of the aqueous sodium metabisulphite solution and of the mixture of monomers to the reactor is initiated using 2 metering pumps, the flow rate of which is adjusted in order for all of the mixture of monomers (366.99 g) and 100% (by weight) of the aqueous solution of reducing agent (19.48 g of solution) to be fed to the reactor over a time of 2 hours 30 minutes. Sparging with nitrogen and stirring are maintained. On completion of the feeding (2 h 30), the medium is left heating at 75° C. for 60 minutes under nitrogen and with stirring. On completion of this heating, the medium is cooled and the nitrogen is cut off. The polycarboxylate copolymer solution thus obtained is discharged from the reactor at <40° C. The solids content, determined by gravimetric analysis, is 44.4%.

Measurement of the Spreading as a Function of Time on a Model Mortar:

The superplasticizer solution is treated with 1% of Clerol antifoaming agent with respect to the solids content.

The values of W/C and of % by weight of superplasticizer (with respect to the cement) are set respectively at 0.54 and 0.175%.

518.5 g of dry cement of Lumbres type, 1 350 g of standard sand (CEN EN 196-1), 2.044 g of aqueous solution of superplasticizer and 278.85 g of drinking water (account taken of the water present in the superplasticizer solution) are weighed out.

The spreading measurements are carried out as described in Example 1.

The change over time in the spreading corresponding to the mortar preparation comprising the superplasticizer of this example is presented in Table I.

The distribution in the molecular masses of the copolymer of this example was determined by steric exclusion chromatography (SEC) according to the technique described above (Example 1). The average molar masses thus determined appear in Table IV.

### COUNTEREXAMPLE 4

### Comparative

The method of preparation described in counterexample 3 for the degassing with nitrogen is followed, except that the amount of demineralized water in the reactor is 92 g. During the degassing with nitrogen, the following three mixtures are prepared:
1) Aqueous solution of reducing agent: 1.9 g of sodium hypophosphite are dissolved in 23.7 g of demineralized water in a suitable receptacle.
2) Aqueous solution of oxidizing agent: 2.60 g of ammonium persulphate (Aldrich) are dissolved in 29.89 g of demineralized water in a suitable receptacle.
3) Mixture of monomers: 1.30 g of methacrylic acid (Atofina) are mixed with 440.61 g of Norsocryl N402 (Atofina) (methoxypolyethylene glycol methacrylate monomer with a side chain of 2 000 g/mol on average of poly(ethylene oxide) units comprising 3.35% by weight of methacrylic acid, which is taken into account in calculating the molar ratios, and 40.8% by weight of water, which is taken into account in the adjustment of the final solids content).

When the thirty minutes of degassing have passed and when the temperature of the reactor is 75° C., all of the aqueous solution of sodium hypophosphite is added. At the same time, the aqueous solution of ammonium persulphate and of the mixture of monomers is initiated using 2 metering pumps, the flow rate of which is adjusted in order for all of the mixture of monomers (441.91 g) and 80% (by weight) of the aqueous solution of oxidizing agent (26 g of solution) to be fed to the reactor over a time of 2 hours 30 minutes. Sparging with nitrogen and stirring are maintained. On completion of the feeding (2 h 30), the medium is left heating at 75° C. for 15 minutes before adding, all at once, the reminder (20% by weight) of the aqueous solution of ammonium persulphate (6,5 g of solution). After this addition, the temperature is maintained with the reactor under nitrogen and stirring for an additional 45 minutes. On completion of this latter heating, the medium is cooled and the nitrogen is cut off. The polycarboxylate copolymer solution thus obtained is discharged from the reactor at a temperature of <40° C. The solids content, determined by gravimetric analysis, is 45%, and the Brookfield viscosity is 38 000 mPa.s. The mixing obtained is very viscous and very difficult to handle. The mortar can not be characterized.

TABLE I
Variation in the spreading as a function of time for the
preparation of Examples 1-5 and Counterexamples 1 and 3,
with respect to the same preparation using a commercial
superplasticizer. In all cases, the W/C ratio is 0.54
(except for Counterexample 1, for which W/C = 0.55) and the
level of superplasticizer is 0.175% with respect to the
cement.

| | | | | | % of |
|---|---|---|---|---|---|
| | | | Mono- | | variation |
| | | Mono- | mers/ | | with |
| | | mers/ | reduc- | Spreading | respect to |
| | A/B/C | oxidizing | ing | (mm) vs | the |
| | Monomers | agent | agent | time | initial |
| Preparation | ratio | ratio | ratio | (min) | spreading |
| Commercial | — | — | — | 262-0 | 0 |
| reference | | | | 264-30 | 0.8 |
| (Glenium 27) | | | | 256-60 | −3.0 |
| | | | | 251-90 | −4.2 |
| | | | | 247-120 | −5.7 |
| Example 1 | 60/40/0 | 25 | 32 | 260-0 | 0 |
| | | | | 260-30 | 0 |
| | | | | 260-60 | 0 |
| | | | | 251-90 | −3.5 |
| | | | | 246-120 | −5.4 |
| Example 2 | 60/40/0 | 25 | 32 | 256-0 | 0 |
| | | | | 257-30 | 0.4 |
| | | | | 253-60 | −1.2 |
| | | | | 248-90 | −3.1 |
| | | | | 245-120 | −4.3 |
| Example 3 | 63/37/0 | 25 | 32 | 341-0 | 0 |
| | | | | 341-30 | 0 |
| | | | | 343-60 | 0.6 |
| | | | | 338-90 | −0.9 |
| | | | | 326-120 | −4.4 |
| Example 4 | 63/37/0 | 25 | 25 | 311-0 | 0 |
| | | | | 333-30 | 7.0 |
| | | | | 337-60 | 8.4 |
| | | | | 345-90 | 10.9 |
| | | | | 366-120 | 17.7 |
| Example 5 | 66/34/0 | 25 | 32 | 366-0 | 0 |
| | | | | 359-30 | −1.9 |
| | | | | 361-60 | −1.4 |
| | | | | 352-90 | −3.8 |
| | | | | 362-120 | −1.1 |
| Counter- | 60/40/0 | 37 | — | 257-0 | 0 |
| example 1 | | | | 252-30 | −1.9 |
| | | | | 245-60 | −4.7 |
| | | | | 236-90 | −8.2 |
| | | | | 221-120 | −14.0 |
| Counter- | 60/40/0 | 25 | 32 | 254-0 | 0 |
| example 3 | | | | 233-30 | −8.3 |
| | | | | 231-60 | −9.1 |
| | | | | 229-90 | −9.8 |
| | | | | 216-120 | −15.0 |

TABLE II
Initial spreadings (at t = 30 seconds) for the preparations
of Examples 6 to 10, with respect to the same preparation
using a reference commercial superplasticizer. In all cases,
the W/C ratio is 0.466 and the level of superplasticizer is
0.175% with respect to the cement.

| | | Monomers/ | Monomers/ | |
|---|---|---|---|---|
| | A/B/C | oxidizing | reducing | Initial |
| | Monomers | agent | agent | spreading |
| Preparation | ratio | ratio | ratio | (mm) |
| Reference: | — | — | — | 325 |
| Glenium ACE-32 | | | | |
| Example 6 | 73/27/0 | 25 | 32 | 347 |
| Example 7 | 74/26/0 | 25 | 32 | 337 |
| Example 8 | 76/24/0 | 25 | 32 | 346 |
| Example 9 | 77/23/0 | 25 | 32 | 346 |
| Example 10 | 78/22/0 | 25 | 32 | 352 |

TABLE III
Variation in the spreading as a function of time for the
preparation of Counterexample 2, with respect to the same
preparation using the superplasticizer of Example 1. In both
cases, the W/C ratio is 0.53 and the level of
superplasticizer is 0.175% with respect to the cement.

| | | | Mono- | | % of |
|---|---|---|---|---|---|
| | | Mono- | mers/ | | variation |
| | | mers/ | reduc- | Spreading | with respect |
| | A/B/C | oxidizing | ing | (mm) vs | to the |
| | Monomers | agent | agent | time | initial |
| Preparation | ratio | ratio | ratio | (min) | spreading |
| Counter- | 60/40/0 | 25 | 60 | 250-0 | 0 |
| example 2 | | | | 231-30 | −7.6 |
| | | | | 223-60 | −10.8 |
| | | | | 217-90 | −13.2 |
| | | | | 215-120 | −14.0 |
| Example 1 | 60/40/0 | 25 | 32 | 254-0 | 0 |
| | | | | 256-30 | 0.8 |
| | | | | 254-60 | 0 |
| | | | | 250-90 | −1.6 |
| | | | | 246-120 | −3.1 |

TABLE IV
Number-average molecular masses Mn, weight-average molecular
masses Mw and polydispersity index Mw/Mn, determined by
steric exclusion chromatography on certain copolymers of the
examples and counterexamples. The values are given in PEG
equivalents.

| | | | Poly- | |
|---|---|---|---|---|
| | Mn | Mw | dispersity | |
| | (number- | (weight- | index | Type of |
| Reference | average) | average) | Mw/Mn | distribution |
| Example 1 | 21 941 | 53 156 | 2.423 | Monomodal with a |
| | | | | small shoulder on |
| | | | | the side of the high |
| | | | | masses |
| Counter- | 148 385 | 354 394 | 2.388 | Bimodal with |
| example 2 | 16 117 | 24 762 | 1.536 | equivalent |
| | | | | proportions of |
| | | | | each peak |
| Example 2 | 20 382 | 37 132 | 1.822 | Monomodal without a |
| | | | | shoulder |
| Counter- | 26 278 | 65 948 | 2.510 | Monomodal with a |
| example 3 | | | | large shoulder on |
| | | | | the side of the high |
| | | | | masses |

TABLE V
Mechanical compressive strength of the mortar test specimens
which are obtained with the superplasticizer of Example 1,
compared with that of a commercial reference.

| | | | Mechanical | Mechanical |
|---|---|---|---|---|
| | | Weight of | strength | strength |
| | % super- | test | (compressive) | (compressive) |
| | plasticizer/ | specimen | at 1 day | at 7 days |
| Reference | cement | (g) | (MPa) | (MPa) |
| Commercial | 0.203 | 562 | 12.42 | 40.44 |
| reference | | | | |
| (Glenium 27) | | | | |
| Example 1 | 0.176 | 591 | 16.19 | 46.75 |

TABLE VI
Mechanical compressive strength of the mortar test specimens
which are obtained with the superplasticizers of Examples 4
and 5. In these two cases, the W/C ratio is 0.58

| | | | | Mechanical |
|---|---|---|---|---|
| | | Weight of | Mechanical | strength |
| | % super- | test | strength | (compressive) |
| | plasticizer/ | specimen | (compressive) | at 7 days |
| Reference | cement | (g) | at 1 day (MPa) | (MPa) |
| Example 4 | 0.200 | 576 | 15.3 | 49.4 |
| Example 5 | 0.250 | 586 | 15.2 | 49.3 |

TABLE VII
Spreadings as a function of time for the preparation of
Example 11 (using potassium metabisulphite as reducing
agent) and of Example 12 (using sodium metabisulphite as
reducing agent). In these two cases, the W/C ratio is 0.54
and the level of superplasticizer is 0.175% with respect to
the cement

| Preparation | Spreading (mm) vs. time (min) |
|---|---|
| Example 11 (potassium metabisulphite) | 289-0 |
| | 285-30 |
| | 279-60 |
| | 274-90 |
| | 265-120 |
| Example 12 (sodium metabisulphite) | 300-0 |
| | 284-30 |
| | 278-60 |
| | 259-90 |
| | 244-120 |

1. Polymeric dispersant of polycarboxylate type comprising at least one copolymer obtained from a monomer composition comprising:
A) 40 to 95 mol % of units derived from at least one unsaturated carboxylic monomer,
B) 5 to 60 mol % of units derived from at least one acrylic ester or methacrylic ester monomer comprising a polyether chain,
C) 0 to 20 mol % of units of at least one third monomer selected from: acrylic ester or methacrylic ester or acrylamide or acrylamide derivative or vinylaromatic monomer or its sulphonated derivative
characterized in that the said copolymer has a controlled molecular mass distribution, which can be obtained by a process comprising the stages of:
i) polymerization in aqueous solution at a temperature ranging from 70 to 95° C. with an initiation and transfer system comprising:
D) an oxidizing agent,
E) a reducing agent, additionally acting as transfer agent, selected from metabisulphite salts, in the absence of any other transfer agent and in an amount such that the monomers/reducing agent molar ratio does not exceed 50,
ii) semi-continuous addition of the oxidizing agent and of the mixture of monomers over a time ranging from 1 to 4 hours,
iii) introduction of the reducing agent, either as vessel heel, before the beginning of the addition of the oxidizing agent and of the monomers, or semi-continuously, mixed with the monomers, or semi-continuously, as separate feed from the latter and from the oxidizing agent.

2. Dispersant according to claim 1, characterized in that the reducing agent E) is selected from sodium metabisulphite or potassium metabisulphite.

3. Dispersant according to claim 1, characterized in that the unsaturated carboxylic monomer is of general formula: 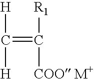
with R¹ being H or CH₃, and M⁺ being a cation selected from: H⁺ or ammonium or metal cation from metals belonging to Groups IA and IIA.

4. Dispersant according to claim 1, characterized in that the unsaturated carboxylic monomer is methacrylic acid.

5. Dispersant according to claim 1, characterized in that the acrylic ester or methacrylic ester monomer comprising a polyether chain is of general formula: 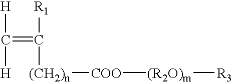
with R₁ being H or CH₃, n being an integer equal to 0, 1 or 2, R₂ being a saturated alkylene group comprising 2, 3 or 4 carbon atoms, m being an integer ranging from 7 to 50 and R₃ being H or a saturated alkyl group comprising 1, 2, 3 or 4 carbon atoms.

6. Dispersant according to claim 1, characterized in that the acrylic ester or methacrylic ester monomer is methoxypolyethylene glycol methacrylate with a polyether chain comprising methoxy units ranging from 20 to 48.

7. Dispersant according to claim 1, characterized in that a third monomer is present and is selected from ethyl acrylate or methyl acrylate or methyl methacryalte or styrene.

8. Dispersant according to claim 1, characterized in that the third monomer C is present at a level ranging from 0.5 to 10 mol %.

9. Dispersant according to claim 1, characterized in that the oxidizing agent is ammonium persulphate and the reducing agent is sodium metabisulphite.

10. Dispersant according to claim 1, characterized in that the monomers/oxidizing agent molar ratio does not exceed the value of 60.

11. Dispersant according to claim 1, characterized in that the monomers/oxidizing agent molar ratio is from 10 to 40.

12. Dispersant according to claim 1, characterized in that the monomers/reducing agent molar ration does not exceed the value of 40.

13. Dispersant according to claim 1, characterized in that the monomers/reducing agent molar ration is from 10 to 40.

14. Dispersant according to claim 1, characterized in that the oxidizing agent is ammonium persulphate and the reducing agent is sodium metabisulphite and in that the monomers/metabisulphite molar ratio is from 10 to 40 and the monomers/persulphate molar ratio is from 10 to 40.

15. Dispersant according to claim 1, characterized in that the polymerization temperature is from 70 to 80° C.

16. Process for the preparation of a dispersant as defined according to claim 1, characterized in that it comprises the stages of:
i) polymerization in aqueous solution, at a temperature ranging from 70 to 95° C., of a mixture of monomers comprising:
A) 40 to 95 mol % of units derived from at least one unsaturated carboxylic monomer,
B) 5 to 60 mol % of units derived from at least one acrylic ester or methacrylic ester monomer comprising a polyether chain,
C) 0 to 20 mol % of units of at least one third monomer selected from: acrylic ester or methacrylic ester or acrylamide or acrylamide derivative or vinylaromatic monomer or its sulphonated derivative
with an initiation and transfer system comprising:
D) an oxidizing agent,
E) a reducing agent, additionally acting as transfer agent, selected from metabisulphite salts, in the absence of any other transfer agent and in an amount such that the monomers/reducing agent molar ratio does not exceed 50,
ii) semi-continuous addition of the oxidizing agent and of the mixture of monomers over a time ranging from 1 to 4 hours,
iii) introduction of the reducing agent, either as vessel heel, before the beginning of the addition of the oxidizing agent and of the monomers, or semi-continuously, mixed with the monomers, or semi-continuously, as separate feed from the latter and from the oxidizing agent.

17. Process according to claim 16, characterized in that the reducing agent E) is selected from sodium metabisulphite or potassium metabisulphite.

18. Dispersant composition, characterized in that it comprises at least one dispersant as defined according to claim 1.

19. Composition according to claim 18, characterized in that the said composition is an aqueous composition comprising the said dispersant at a level of solids content by weight ranging from 5 to 60%.

20. Composition according to claim 19, characterized in that the said composition is an aqueous solution of the said dispersant.

21. Hydraulic binder composition or inorganic particle paste composition or pigment paste composition comprising at least one dispersant as defined according to claim 1.

22. Aqueous polymer dispersion comprising at least one dispersant as defined according to claim 1.

23. Hydraulic binder composition according to claim 21, characterized in that the said composition is a cement paste and in that the water/cement ratio is from 0.2 to 1 and the dispersant/cement ratio is from 0.05/100 to 20/100.

24. Use of the dispersants defined according to claim 1 as plasticizers for aqueous pastes comprising a hydraulic binder or as dispersants for pigment pastes or for aqueous polymer dispersions or resin dispersions.

25. Preparations based on inorganic hydraulic binders comprising the dispersants defined according to claim 1, where the amount of copolymer used, expressed as percentage by dry weight of copolymer with respect to the cement, ranges from 0.05 to 15%.

26. Preparations according to claim 25, additionally comprising surfactants, air-detraining additives, antifoaming agents, softeners, setting retarders, setting accelerators, fillers, biocides or other conventional additives.

27. Hardened articles obtained from compositions as defined according to claim 23.

28. Hardened articles obtained form compositions as defined according to claim 25.
